(19) United States
(12) Patent Application Publication
(10) Pub. No.: US 2021/0354648 A1
(43) Pub. Date: Nov. 18, 2021

(54) AIRBAG DEVICE FOR DRIVERS SEAT

(71) Applicant: HYUNDAI MOBIS CO., LTD., Seoul (KR)

(72) Inventor: Jung Geun CHOI, Yongin-si (KR)

(73) Assignee: HYUNDAI MOBIS CO., LTD., Seoul (KR)

(21) Appl. No.: 17/320,043

(22) Filed: May 13, 2021

(30) Foreign Application Priority Data
May 18, 2020 (KR) 10-2020-0059001

(51) Int. Cl. B60R 21/203; B60R 21/2338; B60R 21/237; B60R 21/26

(52) U.S. Cl. CPC B60R 21/203; B60R 21/2338; B60R 2021/23382; B60R 21/26; B60R 21/237

(57) ABSTRACT

An airbag device for a driver's seat including an inflator that is mounted on a housing provided in a steering wheel; and an airbag cushion that is embedded in the housing and is deployed by gas discharged from the inflator, wherein the airbag cushion comprises: a first panel that is disposed in a direction toward a driver in a deployed state; and a second panel that is provided to face the first panel, is disposed in a direction toward a front of a vehicle in the deployed state, and has a partial area that protrudes and expands toward the front of the vehicle during deployment.

### CROSS-REFERENCE TO RELATED APPLICATION

This application claims the benefit under 35 U.S.C. § 119(a) of Korean Patent Application No. 10-2020-0059001 filed on May 18, 2020 in the Korean Intellectual Property Office, the entire disclosure of which is incorporated herein by reference for all purposes.

### BACKGROUND

### Field

Exemplary embodiments of the present disclosure relate to an airbag device for a driver's seat, and more particularly, to an airbag device for a driver's seat, which has an increased protection area and support force.

### Discussion of the Background

In general, a steering wheel for steering wheels is disposed in front of a driver's seat of a vehicle, and an airbag for a driver's seat is installed in the steering wheel to protect a driver by being inflated and deployed in the event of a vehicle accident.

The airbag for a driver's seat is inflated by internal gas pressure to quickly restrain the head and chest of the driver, thereby preventing the head and chest of the driver from being injured by a collision with the steering wheel.

A rim provided on the steering wheel is generally formed in a circular ring shape, so that an airbag cushion is sufficiently supported through the steering wheel during deployment. Recently, for various purposes such as improvement of display visibility, the rim of the steering wheel is manufactured in various shapes other than circular. However, in such a case, there may occur a problem in that the injury to a passenger becomes worse due to insufficient support of the steering wheel to the airbag for a driver's seat. Accordingly, it is necessary to improve the airbag for a driver's seat so as to cope with various shapes of steering wheels.

The background art of the present disclosure is disclosed in Japan Patent No. 4129758 (registered on May 30, 2008 and entitled “Airbag Device”).

### SUMMARY

Various embodiments are directed to providing an airbag device for a driver's seat, in which when an airbag cushion is deployed, a partial area of a panel facing the front of a vehicle is expanded compared to the other areas, thereby increasing a protection area and support force of the airbag cushion and coping with various shapes of steering wheels.

An airbag device for a driver's seat in accordance with the present disclosure may include: an inflator that is mounted on a housing provided in a steering wheel; and an airbag cushion that is embedded in the housing and is deployed by gas discharged from the inflator, wherein the airbag cushion may include: a first panel that is disposed in a direction toward a driver in a deployed state; and a second panel that is provided to face the first panel, is disposed in a direction toward a front of a vehicle in the deployed state, and has a partial area that protrudes and expands toward the front of the vehicle during deployment.

The second panel may include a panel body, and the panel body may have an expansion part disposed in an upper area of the panel body and expanded to protrude toward the front of the vehicle during deployment.

The expansion part may include a folded part that is formed by folding the upper area of the panel body.

The folded part may be formed by overlapping the upper area of the panel body in a Z shape.

The steering wheel may include a hub part that is provided with the housing and a rim part that is provided in a partial area around the hub part, and when among areas in a circumferential direction centered on the hub part, an area provided with the rim part is referred to as a support area and an area not provided with the rim part is referred to as a non-support area, the expansion part may be provided to be located at a position corresponding to the non-support area during deployment.

One or more folded parts may be provided to overlap the panel body or another adjacent folded part.

In a state in which the airbag cushion is deployed, a size of the expansion part may be adjusted according to the number and sizes of the folded parts.

The airbag device for a driver's seat may further include a tether part that is coupled to surfaces of the first panel and the second panel facing each other, and is provided to restrain the airbag cushion that is deployed.

The second panel may include an inlet hole through which gas is introduced, and the tether part may include an upper tether member and a lower tether member provided on an upper side and a lower side, respectively, based on the inlet hole.

According to the airbag device for a driver's seat in accordance with the present disclosure, when the airbag cushion is deployed, a partial area of the second panel facing the front of a vehicle is expanded compared to the other areas, thereby coping with various shapes of steering wheels and increasing a protection area and support force of the airbag cushion.

According to the airbag device for a driver's seat in accordance with the present disclosure, even when the rim part of the steering wheel is not a circular ring, it is possible to improve the injury to a passenger by sufficiently securing support force of the airbag cushion without any additional parts.

### BRIEF DESCRIPTION OF THE DRAWINGS

FIG. 1 is a view illustrating a steering wheel provided with an airbag device for a driver's seat in accordance with an embodiment of the present disclosure.

FIG. 2 is a sectional view schematically illustrating a state in which the airbag device for a driver's seat in accordance with an embodiment of the present disclosure is mounted.

FIG. 3 is a side view illustrating a state in which the airbag device for a driver's seat in accordance with an embodiment of the present disclosure is deployed.

FIG. 4 is a side sectional view illustrating an airbag cushion in accordance with an embodiment of the present disclosure.

FIG. 5 is an enlarged sectional view of part B of FIG. 4.

FIG. 6 is a view illustrating a second panel in accordance with an embodiment of the present disclosure and illustrates a state in which a folded part is folded.

FIG. 7 is a view illustrating a state in which the folded part of FIG. 6 is unfolded.

### DETAILED DESCRIPTION OF THE ILLUSTRATED EMBODIMENTS

Hereinafter, embodiments of the present disclosure will be described in detail with reference to the accompanying drawings.

First, embodiments to be described below are embodiments suitable for understanding the technical characteristics of an airbag device for a driver's seat in accordance with the present disclosure. However, the present disclosure is not limitedly applied to the embodiments to be described below or the technical characteristics of the present disclosure are not limited by the embodiments to be described below, and various modifications can be made within the technical range of the present disclosure.

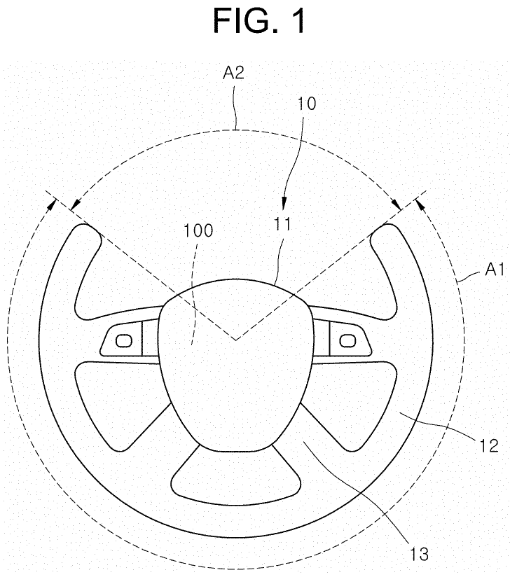

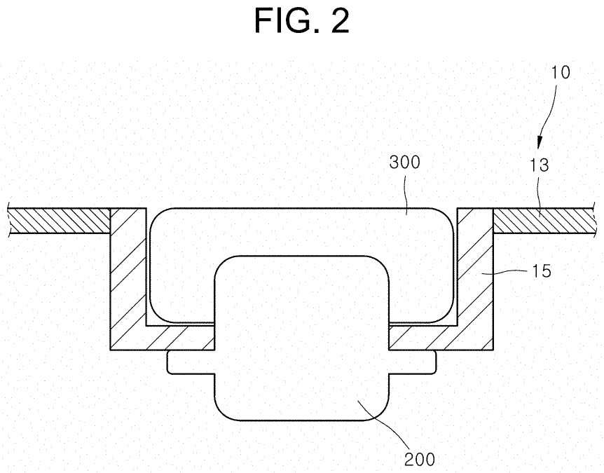

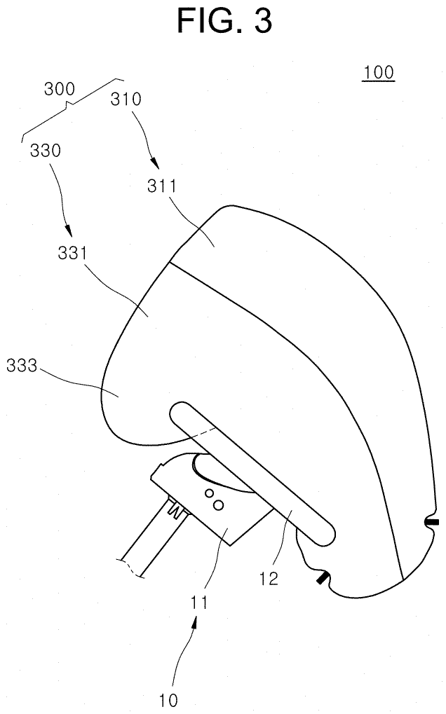

FIG. 1 is a view illustrating a steering wheel 10 provided with an airbag device 100 for a driver's seat in accordance with an embodiment of the present disclosure, FIG. 2 is a sectional view schematically illustrating a state in which the airbag device 100 for a driver's seat in accordance with an embodiment of the present disclosure is mounted, and FIG. 3 is a side view illustrating a state in which the airbag device 100 for a driver's seat in accordance with an embodiment of the present disclosure is deployed.

Referring to FIG. 1 to FIG. 3, the airbag device 100 for a driver's seat in accordance with an embodiment of the present disclosure includes an inflator 200 and an airbag cushion 300.

The inflator 200 is mounted on a housing 15 provided in the steering wheel 10.

Specifically, the steering wheel 10 may include a hub part 11 disposed in the central part thereof, a rim part 12 provided around the hub part 11 and grasped by a driver, and spokes 13 that connect the rim part 12 to the hub part 11. The housing 15 may be mounted on the hub part 11 of the steering wheel 10.

The rim part 12 may also be formed in a circular ring shape around the hub part 11, or may also be formed in a state in which a part of the circular ring shape is removed. For example, the rim part 12 may be formed in an arc shape, in which a part of an upper end thereof is removed, in order to secure the driver's field of view during driving (FIG. 1). Furthermore, for example, for convenience or aesthetic reasons, the rim part 12 may also have a shape whose lower end or side portion is cut off or a ring shape other than a circular shape.

The inflator 200 may be mounted on the housing 15. For example, the inflator 200 may operate when a collision is detected through a collision detection sensor (not illustrated), and discharge gas.

The airbag cushion 300 may be embedded in the housing 15, and may be deployed by gas discharged from the inflator 200 to protect a passenger. For example, the airbag cushion 300 may be made of an elastic material, and may be inflated by the supply of gas to contact a passenger, thereby absorbing an impact transferred to the passenger.

The airbag cushion 300 may be coupled to the inflator 200 and accommodated in the housing 15 in a folded state. Furthermore, when gas is discharged from the inflator 200, the airbag cushion 300 may be deployed to the outside while crushing a cover portion of the housing 15 and protect the passenger.

The airbag cushion 300 includes a first panel 310 and a second panel 330. The first panel 310 may be disposed in a direction toward the driver in a deployed state.

The second panel 330 may be provided to face the first panel 310, may be disposed in a direction toward the front of a vehicle in the deployed state, and a partial area of the second panel 330 may be expanded to protrude toward the front of the vehicle during deployment.

Specifically, the first panel 310 and the second panel 330 may be sewn while overlapping each other to form a chamber. The second panel 330 may include an inlet hole 337 that is connected to the inflator 200 to introduce gas into the chamber. When gas is introduced through the inlet hole 337, the airbag cushion 300 may be deployed while the chamber between the first panel 310 and the second panel 330 is inflated. The deployed airbag cushion 300 protects the driver who contacts the first panel 310, in the state in which the second panel 330 is supported by the steering wheel 10.

When the rim part 12 provided on the steering wheel 10 is not circular, the passenger may be injured because support force for supporting the inflated airbag cushion 300 is not sufficient. For example, as illustrated in FIG. 1 and FIG. 3, when the rim part 12 has an arc shape in which a part of the upper end thereof is cut off, the inflated airbag cushion 300 may injure the head, neck, and the like of the passenger due to the lack of support of the rim part 12 to the upper end.

In order to solve such a problem, the present disclosure allows a partial area of the second panel 330 facing the front of the vehicle to be expanded compared to the other areas when the airbag cushion 300 is deployed, thereby securing sufficient support force.

For example, as described above, when the rim part 12 has an arc shape whose upper end is removed, a partial area of the upper end of the second panel 330 may be expanded compared to the other areas. Therefore, it is possible to secure the support force of the upper end of the second panel 330, which is not supported by the rim part 12.

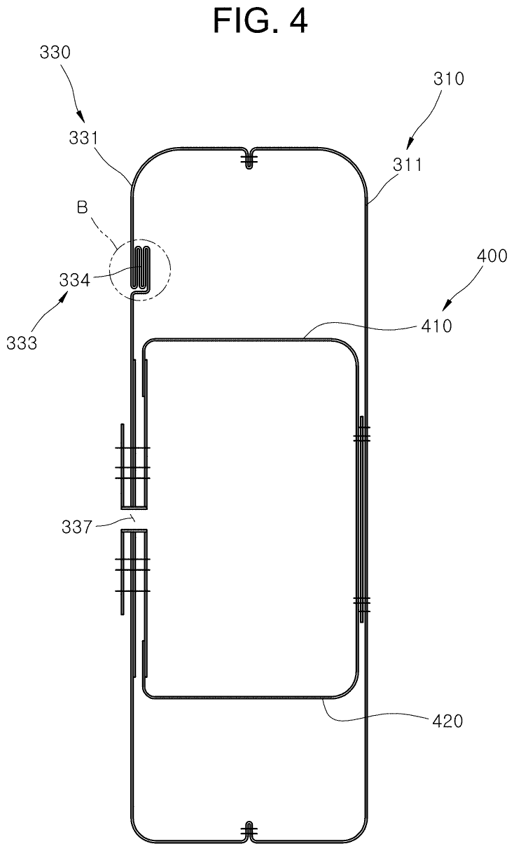

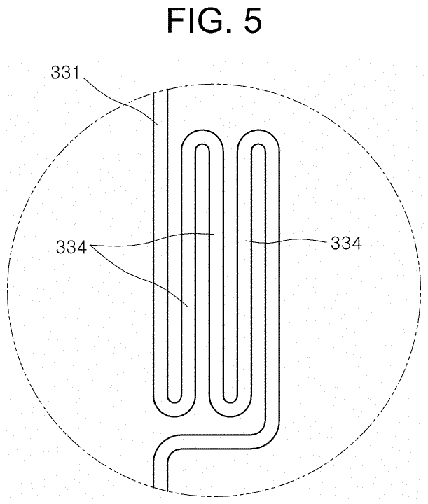

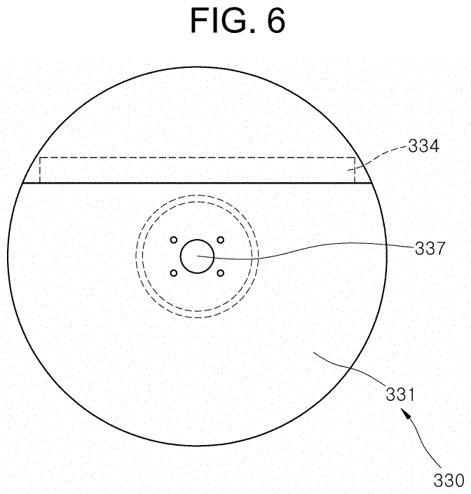

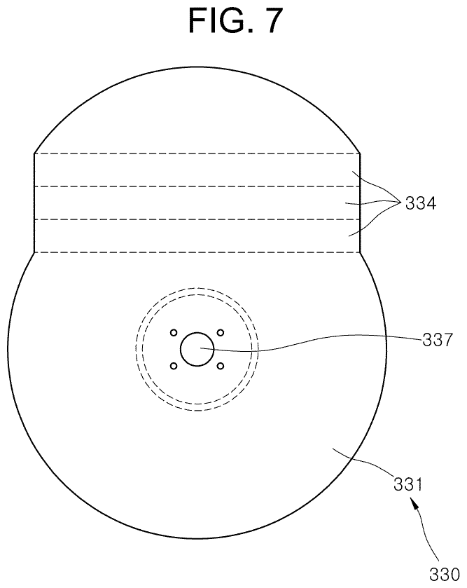

FIG. 4 is a side sectional view illustrating the airbag cushion 300 in accordance with an embodiment of the present disclosure is deployed, and FIG. 5 is an enlarged sectional view of part B of FIG. 4. FIG. 6 is a view illustrating the second panel 330 in accordance with an embodiment of the present disclosure and illustrates a state in which a folded part 334 is folded, and FIG. 7 is a view illustrating a state in which the folded part 334 of FIG. 6 is unfolded.

Referring to FIG. 4 to FIG. 7, the second panel 330 may include a panel body 331 and the folded part 334.

The panel body 331 is a body constituting the second panel 330 and the inlet hole 337 may penetrate through the panel body 331. The panel body 331 may be sewn together with a panel body 311 which is a body constituting the first panel 310.

The folded part 334 may be formed on an expansion part 333 that is a partial area of the panel body 331 and is expanded to protrude toward the front of the vehicle during deployment. Furthermore, the folded part 334 may be provided in the form of being folded in multiple stages in the state in which the airbag cushion 300 is folded in the housing 15, and may be unfolded and expanded when the airbag cushion 300 is deployed.

Specifically, the expansion part 333 may mean a partial area of the panel body 331, and may be in a state folded in multiple stages or an inflated and expanded state. The folded part 334 is a configuration for implementing the expansion part 333 and at least one folded part 334 may be provided. When one folded part 334 is provided, the folded part 334 may overlap another panel body. Furthermore, when a plurality of folded parts 334 are provided, adjacent other folded parts 334 among the plurality of folded parts 334 may overlap each other to be provided in a state of being folded in multiple stages (see FIG. 4 to FIG. 6), and may be unfolded during deployment (see FIG. 7).

For example, the rim part 12 of the steering wheel 10 may be provided in a partial area around the hub part 11. Hereinafter, for convenience of description, among areas in a circumferential direction centered on the hub part 11, an area provided with the rim part 12 is referred to as a support area A1 and an area not provided with the rim part 12 is referred to as a non-support area A2. During inflation, the airbag cushion 300 may be sufficiently supported by the rim part 12 in the support area A1, but support force may be insufficient because there is no rim part 12 in the non-support area A2.

The expansion part 333 may be provided to be located at a position corresponding to the non-support area A2 during deployment. Referring to FIG. 3, during deployment, the expansion part 333 may protrude toward the front of the vehicle in the non-support area A2 and may be inflated to a part not provided with the rim part 12. The expansion part 333 is additionally inflated to cover the non-support area A2 of the steering wheel 10, thereby increasing the support force of the airbag device 100 and protecting the passenger.

As illustrated in FIG. 5 to FIG. 7, a plurality of folded parts 334 may be continuously provided, and any one of the plurality of folded parts 334 may be provided to overlap the other folded parts 334 adjacent to each other. The airbag cushion 300 may be folded in a state in which the adjacent folded parts 334 overlap each other and are folded.

Then, when the airbag cushion 300 is inflated and deployed in a direction toward the driver, the folded parts 334 may be unfolded and the expansion part 333 may be expanded to the front of the vehicle.

The volume of the expansion part 333 may be adjusted. Specifically, in the state in which the airbag cushion 300 is deployed, the size of the expansion part 333 may be adjusted according to the number and sizes of the folded parts 334. That is, the folded part 334 may be formed by folding a part of the panel body 331, and the number and sizes of the folded parts 334 may be adjusted by adjusting the number of times of folding and a folding interval.

Referring to FIG. 4, the present disclosure may further include a tether part 400. The tether part 400 may be coupled to surfaces of the first panel 310 and the second panel 330 facing each other, and provided to restrain the airbag cushion 300 that is deployed.

Specifically, both ends of the tether part 400 may be fixed to the surface of the first panel 310 toward the second panel 330 and the surface of the second panel 330 toward the first panel 310. The tether part 400 may restrain the airbag cushion 300 that is deployed in a direction toward the driver when the airbag cushion 300 is inflated.

For example, the tether part 400 may include an upper tether member 410 and a lower tether member 420. One end of the upper tether member 410 may be coupled to an upper side based on the inlet hole 337. Furthermore, one end of the lower tether member 420 may be coupled to a lower side based on the inlet hole 337. However, the coupling position and configuration of the tether part 400 in accordance with the present disclosure are not limited to those described above, and can be variously modified as long as the airbag cushion 300 can be properly restrained.

As described above, according to the airbag device for a driver's seat in accordance with the present disclosure, when the airbag cushion is deployed, a partial area of the second panel facing the front of a vehicle is expanded compared to the other areas, thereby coping with various shapes of steering wheels and increasing a protection area and support force of the airbag cushion.

According to the airbag device for a driver's seat in accordance with the present disclosure, even when the rim part of the steering wheel is not a circular ring, it is possible to prevent the injure to a passenger by sufficiently securing support force for the airbag cushion without any additional parts.

So far, although specific embodiments of the present disclosure have been described above, the spirit and scope of the present disclosure are not limited by such specific embodiments, and various corrections and modifications can be made by those skilled in the art in the technical field, to which the present disclosure pertains, without changing the subject matter of the present disclosure defined in the appended claims.

What is claimed is:

1. An airbag device for a driver's seat, comprising:
an inflator that is mounted on a housing provided in a steering wheel; and
an airbag cushion that is embedded in the housing and is deployed by gas discharged from the inflator,
wherein the airbag cushion comprises:
a first panel that is disposed in a direction toward a driver in a deployed state; and
a second panel that is provided to face the first panel, is disposed in a direction toward a front of a vehicle in the deployed state, and has a partial area that protrudes and expands toward the front of the vehicle during deployment.

2. The airbag device according to claim 1, wherein the second panel includes a panel body, and
the panel body has an expansion part disposed in an upper area of the panel body and expanded to protrude toward the front of the vehicle during deployment.

3. The airbag device according to claim 2, wherein the expansion part includes a folded part that is formed by folding the upper area of the panel body.

4. The airbag device according to claim 3, wherein the folded part is formed by overlapping the upper area of the panel body in a Z shape.

5. The airbag device according to claim 4, wherein the steering wheel includes a hub part that is provided with the housing and a rim part that is provided in a partial area around the hub part, and
when among areas in a circumferential direction centered on the hub part, an area provided with the rim part is referred to as a support area and an area not provided with the rim part is referred to as a non-support area, the expansion part is provided to be located at a position corresponding to the non-support area during deployment.

6. The airbag device according to claim 3, wherein one or more folded parts are provided to overlap the panel body or another adjacent folded part.

7. The airbag device according to claim 6, wherein in a state in which the airbag cushion is deployed, a size of the expansion part is adjusted according to a number and sizes of the one or more folded parts.

8. The airbag device according to claim 1, further comprising:
a tether part that is coupled to surfaces of the first panel and the second panel facing each other, and is provided to restrain the airbag cushion that is deployed.

9. The airbag device according to claim 8, wherein the second panel includes an inlet hole through which gas is introduced, and
the tether part includes an upper tether member and a lower tether member provided on an upper side and a lower side, respectively, based on the inlet hole.
